(19) United States
(12) Patent Application Publication
(10) Pub. No.: US 2013/0322628 A1
(43) Pub. Date: Dec. 5, 2013

(54) APPARATUS AND METHOD FOR TRANSCEIVING CONTENT IN A DIGITAL BROADCAST SYSTEM

(71) Applicants: Sung-Ryeul Rhyu, Yongin-si (KR); Jae-Yeon Song, Seoul (KR)

(72) Inventors: Sung-Ryeul Rhyu, Yongin-si (KR); Jae-Yeon Song, Seoul (KR)

(21) Appl. No.: 13/984,692

(22) PCT Filed: Feb. 13, 2012
(86) PCT No.: PCT/KR12/01045

§ 371 Date: Aug. 9, 2013

(30) Foreign Application Priority Data
Feb. 11, 2011 (KR) 10-2011-0012480

(51) Int. Cl. H04L 29/06

(52) U.S. Cl. CPC H04L 63/0428
USPC 380/255

(57) ABSTRACT

A method for transmitting content in a digital broadcast system is provided. The method for transmitting content in a broadcast system includes a process of generating user-preference content and forced-view content, a process of dividing the user-preference content and forced-view content into data units, and a process of performing repeated encryption by inserting an encryption key into at least one of the data units of the forced-view content with the exception of the first data unit. The encryption key includes a key capable of decrypting the next data unit for each data unit.

### CROSS-REFERENCE TO RELATED APPLICATION(S)

This application is a National Stage application under 35 U.S.C. §371 of an International application filed on Feb. 13, 2012 and assigned application No. PCT/KR2012/001045, and claims the benefit under 35 U.S.C. §365(b) of a Korean patent application filed on Feb. 11, 2011 in the Korean Intellectual Property Office and assigned Serial No. 10-2011-0012480, the entire disclosure of which is hereby incorporated by reference.

### TECHNICAL FIELD

The present disclosure relates to a digital broadcasting system. More particularly, the present disclosure relates to a transceiving apparatus and method for a content that is provided to a user through a digital broadcasting system.

### BACKGROUND

In the current digital broadcasting technology, as a communication technology has developed and wired/wireless Internet has dramatically developed, a variety of types of Internet TeleVision (TV) significantly affect the lives of users. A representative digital broadcast includes Digital Multimedia Broadcasting (DMB), Digital Video Broadcasting—Handheld (DVB-H), Internet Protocol TV (IPTV), smart TV, and the like. Technologies for providing convenience to users in association with the digital broadcast have been continuously developed.

Following this trend, the number of users who use online contents have increased and thus, smooth transmission has been regarded as important. Therefore, an adaptive streaming technology that performs transmission by changing a bit rate of a content to be smooth based on an available transmission bandwidth or a change in the performance of a device of a user, has become a technology of interest. The adaptive streaming technology optimizes a bit rate by analyzing a network environment of the user. Many standard groups have discussed transmission technologies in which a user terminal selects and plays back, according to a situation, a unit of a content that has been divided into small parts based on a Hyper Text Transfer Protocol (HTTP) so that the user may use the content without delay or disconnection, like an adaptive streaming technology. Among the technologies, a convergence of communication and broadcasting based on Internet Protocol (IP) has been regarded as a new marketable business model for the next generation, and has drawn attention as one of the next generation technologies that will lead the market. Particularly, the most important technology of a Convergence of Broadcasting and Mobile Service (CBMS) is IPTV that provides a service by recombining or combining an existing TV service, a voice service, and a data technology, and supports interactivity so that various business models and services may be provided. Particularly, the IPTV technology provides a service regardless of a terminal and a network, that is, it may provide service through a stationary terminal such as a set-top box, a Personal Computer (PC), and a TV, a mobile terminal such as a portable terminal, a Personal Digital Assistants (PDA), and the like, a wired network, a wireless network, a broadcast network, and the like, as opposed to providing a specified service that is provided in a limited terminal environment such as an existing terminal environment. Therefore, an identical service may be provided or applied in various environments, and a variety of types of services may be suggested by considering various environments.

As a representative technology of the HTTP-based adaptive streaming technologies, Motion Picture Expert Group-Dynamic Adaptive Streaming over HTTP (MPEG-DASH) and 3^{rd} Generation Partnership Project-DASH (3GPP-DASH) are used.

The MPEG-DASH is a standard for a technology for achieving an Audio/Video (AV) streaming that is dynamic and adaptive to a wired/wireless Internet network environment and a terminal environment according to the trend of the AV streaming based on a HTTP/Transmission Control Protocol (TCP) as opposed to an AV streaming based on a Real Time Protocol/User Datagram Protocol (RTP/UDP) that is interrupted by an Internet firewall. Conversely, the 3GPP-DASH is a standard for a HTTP-based streaming technology for a wireless communication network in 3GPP.

FIG. 1 is a diagram illustrating a case in which a Multimedia Presentation Description (MPD) corresponding to a metadata file is transmitted from a server to a client device in a general DASH-based streaming service according to the related art. FIG. 2 is a diagram illustrating a case in which a malicious user hacks an MPD that is received by a client device in a general DASH-based streaming service according to the related art. FIG. 3 is a diagram illustrating a comparison between a process of playback in a normal client device and a process of playback in a hacked client device, in a general DASH-based streaming service according to the related art.

Hereinafter, problems that may occur in a general DASH-based streaming service technology will be described with reference to FIGS. 1, 2, and 3.

A server 100 encrypts an MPD 105, and transmits the encrypted MPD 110 to a client 150. The client device 150 plays back an MPD 155 received from the server 100. A content that a user desires to view (for example, dramas, movies, sports, news, and the like) (hereinafter, referred to as a user-preferred content) and a content that an advertiser desires to provide to a user (hereinafter, referred to as a forced-view content) may be distinguished. However, a malicious user may hack the client device 150 so as to play back only the user-preferred content and not to play back an advertising content. In this instance, the advertiser may suffer damage since the advertiser pays a service provider on condition that a user views an advertising content.

Therefore, to address the problem, the current DASH technology defines that a content of the MPD 105 is encrypted into the MPD 110 for provision. However, the client device 150 performs decryption with respect to the encrypted MPD 155 so as to play back the encrypted MPD 155 as illustrated in FIG. 2. When hacking is performed through manipulation by a malicious user as shown in diagram 160 after the decryption, the client device 150 may enable a user to selectively view the user-preferred content and not the forced-view content. When the client device 150 is hacked as described above, encryption 110 of the MPD 105 performed in the server 100 may be disabled.

FIG. 3 illustrates processes of playing back a user-preferred content 300a and 300b and an advertising content 320a and 320b included in an MPD received from a server, in a normal client device 300 and a client device 350 hacked by a malicious user according to the related art.

That is, the diagram 310 of FIG. 3 shows an order of playback of the advertising content 320a and 320b corresponding to a forced-view content and a drama 300a and 300b corresponding to a user-preferred content included in the MPD received by a client device 300 of a normal user. The diagram 360 shows an order of playback of the received MPD and an associated content in a client device 350 hacked by a malicious user. In FIG. 3, the drama 300a and 300b is used as an example of a user-preferred content, and shows playback of an advertising content 320a and 320b for one minute after playing back a drama for 30 minutes.

As described above, the client device 300 of a normal user plays back an advertisement 320a and 320b inserted between dramas 300a and 300b for approximately one minute, as illustrated in the diagram 310. However, the client device 350 hacked by a malicious user performs playback by skipping the advertising content 320a and 320b inserted between the dramas 300a and 300b as shown in the diagrams 365 and 370. In the case of the diagrams 365 and 370, a viewer skips an advertisement and a corresponding advertiser may suffer damage.

The above information is presented as background information only to assist with an understanding of the present disclosure. No determination has been made, and no assertion is made, as to whether any of the above might be applicable as prior art with regard to the present disclosure.

### SUMMARY

Aspects of the present disclosure are to address at least the above-mentioned problems and/or disadvantages and to provide at least the advantages described below. Accordingly, an aspect of the present disclosure is to provide a content transceiving method and apparatus in a broadcasting service of an adaptive streaming scheme.

Another aspect of the present disclosure is to provide a content transceiving method and apparatus for preventing a malicious attack by a user on a Multimedia Presentation Description (MPD) in a broadcasting service of an adaptive streaming scheme.

Another aspect of the present disclosure is to provide a method and apparatus for providing an advertising content to a user in a broadcasting service of an adaptive streaming scheme.

Another aspect of the present disclosure is to provide a method and apparatus for providing a user-preferred content and a forced-view content to a user in a broadcasting system of an adaptive streaming scheme.

In accordance with an aspect of the present disclosure, a method of transmitting a content in a broadcasting system is provided. The method includes generating a user-preferred content and a forced-view content, dividing the user-preferred content and the forced-view content into data units, and repeatedly performing encryption by inserting an encryption key into at least one data unit from among the data units remaining after excluding a first data unit from the data units forming the forced-view content, wherein the encryption key corresponds to a key that is capable of decrypting a next data unit for each data unit.

In accordance with another aspect of the present disclosure, an apparatus for transmitting a content in a broadcasting system is provided. The apparatus includes a content generating unit that generates a user-preferred content and a forced-view content, and a content processor that divides the user-preferred content and the forced-view content into data units that are basic units for playback, and repeatedly performs encryption by inserting an encryption key into at least one data unit from among the data units remaining after excluding a first data unit from the data units forming the forced-view content, wherein the encryption key includes a key for decrypting a next data unit for each data unit.

In accordance with another aspect of the present disclosure, a method of receiving a content in a broadcasting system is provided. The method includes receiving, from a server, data units including a user-preferred content and a forced-view content, determining whether encryption is performed with respect to the received data units, decrypting a data unit of the received data units using an encryption key included in a previously received data unit when encryption is performed, and performing audio/video decoding with respect to the decrypted data unit.

In accordance with another aspect of the present disclosure, an apparatus for receiving a content in a broadcasting system is provided. The apparatus includes a receiving unit that receives, from a server, data units including a user-preferred content and a forced-view content, a content processor that determines whether encryption is performed with respect to the received data units, decrypts a data unit of the received data units using an encryption key included in a previously received data unit when encryption is performed, and performs audio/video decoding with respect to the decrypted data unit.

The present disclosure prevents a malicious user from hacking an MPD in an adaptive streaming-based broadcasting system.

In a technique described in the present disclosure a user mandatorily views a forced-view content such as an advertising content before being provided with a desired content and thus, an advertisement is viewed by the user as per an intension of an advertiser.

Other aspects, advantages, and salient features of the disclosure will become apparent to those skilled in the art from the following detailed description, which, taken in conjunction with the annexed drawings, discloses various embodiments of the present disclosure.

### BRIEF DESCRIPTION OF THE DRAWINGS

The above and other aspects, features, and advantages of certain embodiments of the present disclosure will be more apparent from the following description taken in conjunction with the accompanying drawings, in which:

FIG. 1 is a diagram illustrating a case in which a Multimedia Presentation Description (MPD) is transmitted from a server to a client device in a general Dynamic Adaptive Streaming over Hyper Text Transfer Protocol (HTTP) (DASH)-based streaming service according to the related art;

FIG. 2 is a diagram illustrating a case in which a malicious user hacks an MPD received by a client device in a general DASH-based streaming service according to the related art;

FIG. 3 is a diagram illustrating a comparison of processes of playing back a content in a normal client and a hacked client in a general DASH-based streaming service according to the related art;

FIG. 4 is a diagram illustrating a structure of a content according to an embodiment of the present disclosure;

FIG. 5 is a schematic diagram illustrating a structure of a movie fragment according to an embodiment of the present disclosure;

FIG. 6 is a block diagram illustrating a content providing device according to an embodiment of the present disclosure;

FIG. 7 is a block diagram illustrating a content processor of FIG. 6 according to an embodiment of the present disclosure;

FIG. 8 is a schematic flowchart of a method of a server device that generates and transmits a content according to an embodiment of the present disclosure;

FIG. 9 is an operational flowchart of a server device that generates and transmits a forced-view content and a user-preferred content according to an embodiment of the present disclosure;

FIG. 10 is a block diagram illustrating a user client that receives and provides a content to a user according to an embodiment of the present disclosure; and

FIG. 11 is a flowchart of a content receiving method of a client device according to an embodiment of the present disclosure.

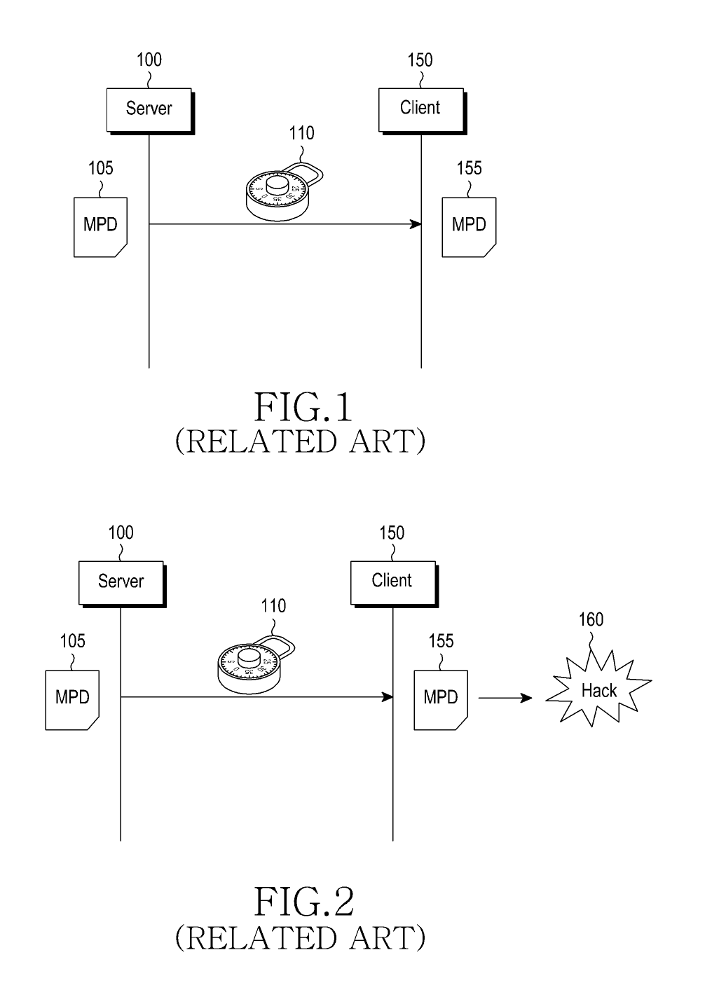

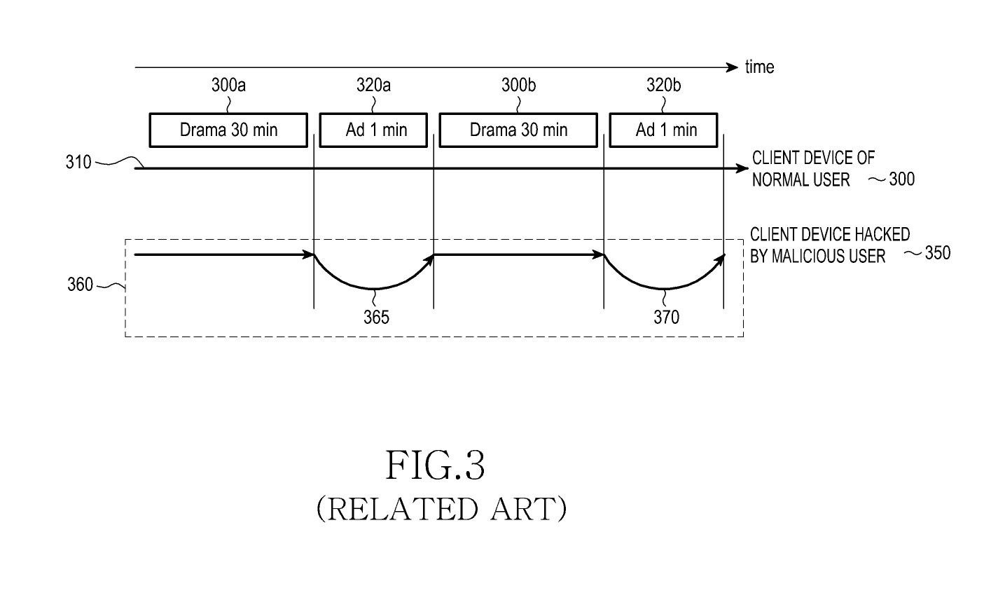

The same reference numerals are used to represent the same elements throughout the drawings.

### DETAILED DESCRIPTION

The following description with reference to the accompanying drawings is provided to assist in a comprehensive understanding of various embodiments of the present disclosure as defined by the claims and their equivalents. It includes various specific details to assist in that understanding but these are to be regarded as merely exemplary. Accordingly, those of ordinary skill in the art will recognize that various changes and modifications of the various embodiments described herein can be made without departing from the scope and spirit of the present disclosure. In addition, descriptions of well-known functions and constructions may be omitted for clarity and conciseness.

The terms and words used in the following description and claims are not limited to the bibliographical meanings, but, are merely used by the inventor to enable a clear and consistent understanding of the present disclosure. Accordingly, it should be apparent to those skilled in the art that the present disclosure is provided for illustration purpose only and not for the purpose of limiting the present disclosure as defined by the appended claims and their equivalents.

It is to be understood that the singular forms “a,” “an,” and “the” include plural referents unless the context clearly dictates otherwise. Thus, for example, reference to “a component surface” includes reference to one or more of such surfaces.

Hereinafter, a structure of a content and a content providing device and method for preventing skipping of an advertisement when a malicious user views a content through a hacked client device, will be described. The present disclosure is also applied to a Dynamic Adaptive Streaming over Hyper Text Transfer Protocol (HTTP) (DASH) and an adaptive streaming technology.

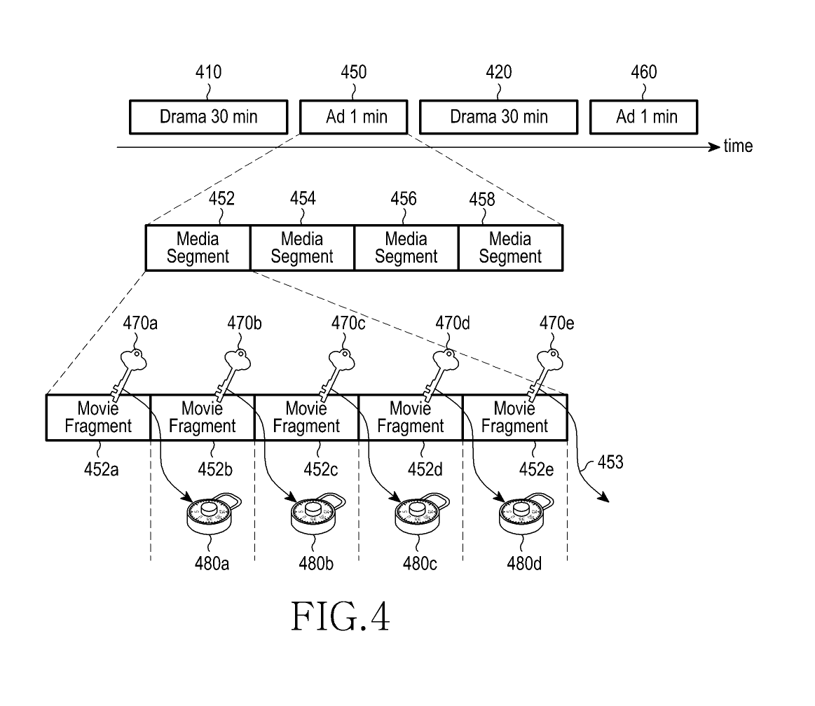

FIG. 4 is a diagram illustrating a structure of a content according to an embodiment of the present disclosure.

First, an embodiment of the present disclosure inserts a decryption key used for playing back an encrypted content into a media segment or a movie fragment corresponding to an advertising content. That is, when a broadcasting service of an adaptive streaming scheme is encrypted for each media segment that is a type of unit forming a content, an encryption key may be inserted into a media segment. When encryption is performed for each movie fragment that is a unit forming the media segment, an encryption key may be inserted into the movie fragment. In the present disclosure, it is described that an encrypted media segment (or an encrypted movie fragment) is decrypted through an encryption key that encrypts the media segment (or the movie fragment). Therefore, the encryption key that encrypts the media segment (or the movie fragment) is identical to an encryption key for decrypting the encrypted media segment (or the encrypted movie fragment).

FIG. 4 shows that a single media segment is formed of a plurality of movie fragments, and a movie fragment includes a plurality of pieces of frame information. Here, the frame information includes a video, an audio, or a Supplementary Enhanced Information (SEI).

A method of providing an advertising content when encryption is performed based on a movie fragment unit will be described in detail with reference to FIG. 4. In the present disclosure, an encryption key 470a used for playing back a content is inserted into a first movie fragment 452a included in a first media segment 452 from among a plurality of media segments 452, 454, 456, and 458 included in an advertising content 450. Here, the encryption key 470a inserted into the first movie fragment 452a is used for decrypting a subsequent movie fragment 452b. That is, according to an embodiment of the present disclosure, a server that generates and transmits a content may apply encryption to movie fragments included in the media segments 452, 454, 456, and 458 of the advertising contents 450 and 460, when configuring media segments of an advertising contents 450 and 460 and media segments of a user-preferred contents 410 and 420. Also, according to an embodiment of the present disclosure, the server encrypts movie fragments included in a few media fragments from among the media fragments forming the user-preferred content. An encryption key used for decrypting the encrypted movie fragment is inserted into a movie fragment included in the advertising content for transmission and thus, a user may obtain the encryption key only after viewing the advertising content. The diagram 480a of FIG. 4 indicates that the movie fragment 452b is encrypted by the encryption key 470a, the diagram 480b indicates that a movie fragment 452c is encrypted by an encryption key 470b, the diagram 480c indicates that a movie fragment 452d is encrypted by an encryption key 470c, and the diagram 480d indicates that a movie fragment 452e is encrypted by an encryption key 470d.

When an encryption section in the advertising content is formed of a plurality of movie fragments, the first movie fragment 452a included in the first media segment 452 may not be encrypted. Accordingly, the user needs to play back a forced-view content corresponding to the advertising content from the beginning so as to view a user-preferred content.

In the present disclosure, each fragment included in the advertising content 450 includes a key 470a, 470b, 470c, 470d, and 470e for decrypting a subsequent movie fragment and thus, a subsequent movie fragment may not be decrypted without playback of a corresponding movie fragment, as shown in FIG. 4.

Although FIG. 4 illustrates that encryption is performed with respect to the movie fragments remaining after excluding the first movie fragment of the movie fragments included in the media segment 452, it is merely an example. When an encryption is performed based on a movie fragment unit, encryption may be performed with respect to a few movie fragments of the movie fragments included in a single media segment.

As another example, when encryption is performed based on a media segment unit that forms an advertising content, encryption may be performed with respect to the media segments remaining after excluding a first media segment of the media segments forming the advertising content, or may be performed with respect to a few media segments. In this example, an encryption key for decrypting an encrypted content may be included based on a media segment unit, as opposed to a movie fragment unit.

Hereinafter, a media segment and a movie fragment are referred to as data units for playing back a content. Although the present disclosure refers to the media segment and the movie fragment as a data unit, a basic unit for transmitting or playing back a content may be included.

In the present disclosure, a target for encryption is a media segment or a movie fragment, but an encryption key may be included in only a movie fragment. However, the present disclosure may not be limited thereto.

As described above, to prevent hacking by a malicious user, a client device may obtain an encryption key only after playing back a data unit for playback of an advertising content. In this example, the encryption key is inserted into a video and audio data, as opposed to being inserted into a File Format (FF) structure of a data unit for playing back a content. The file format structure is divided into media segments or movie fragments, but the client device may not be aware of contents included in a movie fragment. Therefore, the client device needs to extract only data corresponding to the contents from the data received from the server and thus, may be aware of data that may be interpreted by a video/audio decoder.

Therefore, in an embodiment of the present disclosure, information associated with a location of data of a content corresponding to a certain time is described in the file format structure of a basic data unit for playback of a content and thus, the content may be interpreted without a separate decoding process. Therefore, according to an embodiment of the present disclosure, a decryption key is located between video and audio data, as opposed to the file format structure.

A reason that an encryption key is included between the video and audio data, as opposed to a file format structure is as follows. When the encryption key is included in the file format, and the client device is hacked, a media segment or a movie fragment of a desired content is read using a file format parser by analyzing a Multimedia Presentation Description (MPD) so as to play back only the desired content and thus, the encryption key located in the file format structure may be read.

In this case, the hacked client device may obtain the encryption key without playing back the media segment or the movie fragment although the hacked client device may load and read the media segment or the movie fragment and thus, an advertisement may not be played back despite an intention of an advertiser. Therefore, to supplement the weak points, the present embodiment places an encryption key between the video and audio data, as opposed to the file format structure. When the encryption key is inserted between the video and audio data in an SEI message form (subsidiary information message associated with video or audio data), the client device operates the video and audio decoder and plays back the video and audio data and thus, may obtain the encryption key. Also, when a time section in which the encryption key is included contains an advertisement intended by the advertiser, even the hacked client device inevitably plays back the advertisement.

Due to the reasons described above, the client device may not obtain the encryption key for playing back the content by merely receiving content data since the encryption key exists between the video and audio data and thus, decoding needs to be performed first with respect to the data received through the video/audio decoder.

In general, the decoder is closely associated with a decoder buffer and a presentation engine that shows a decoded screen and thus, it is significantly difficult for a user to make a decoder perform decoding and make an associated screen not be shown through hacking. Therefore, the present disclosure provides a high encryption level by placing the encryption key between video and audio data.

The decryption key according to an embodiment of the present disclosure may be inserted into all data units forming a content, or may be randomly inserted into a few data units.

Referring again to FIG. 4, a movie fragment included in an advertising content 450 and 460 according to an embodiment of the present disclosure may include an encryption key for a subsequent movie fragment. Therefore, the client device fails to obtain the encryption key for decrypting the subsequent movie fragment without decoding the corresponding movie fragment and thus, the subsequent movie fragment may not be played back.

For example, when the last movie fragment 452e included in the media segment 452 is not played back, a subsequent media segment 454 may not be played back. A first movie fragment of the media segment 454 is encrypted by the encryption key 470e included in the last movie fragment 452e of the first media segment 452, as shown in the diagram 453.

Therefore, when successive media segments (or movie fragments) included in the advertising content 450 and 460 are decoded, and played back from the beginning, the user-preferred content 410 and 420 may be played back. Although FIG. 4 illustrates that encryption keys 470a through 470e are inserted into all movie fragments included in each media segment, this is merely an example, and encryption may be performed with respect to a few movie fragments. In this case, an encryption key for decrypting an encrypted movie fragment is inserted into a movie fragment located directly before the encrypted movie fragment. When encryption is performed based on a media segment unit, an encryption key may be inserted for each media segment, as opposed to being inserted for each movie fragment.

Therefore, when the client device according to an embodiment of the present disclosure downloads an advertising content and a user-preferred content for playback in a form of data units obtained by dividing the advertising content and the user-preferred content based on a few seconds through a few minutes, playback of the advertising content first is a prerequisite condition for playback of the user-preferred content. Therefore, the user inevitably views the advertising content in accordance with the intention of the advertiser. Accordingly, skipping an advertising section by a user through a double speed playback, a random access, and the like may be prevented. For this, an MPD may include a content identifier so as to distinguish a media segment (or a movie fragment) corresponding to an advertising content and a media segment (or a movie fragment) corresponding to a user-preferred content, and provides a different operation for each of the advertising content and the user-preferred content.

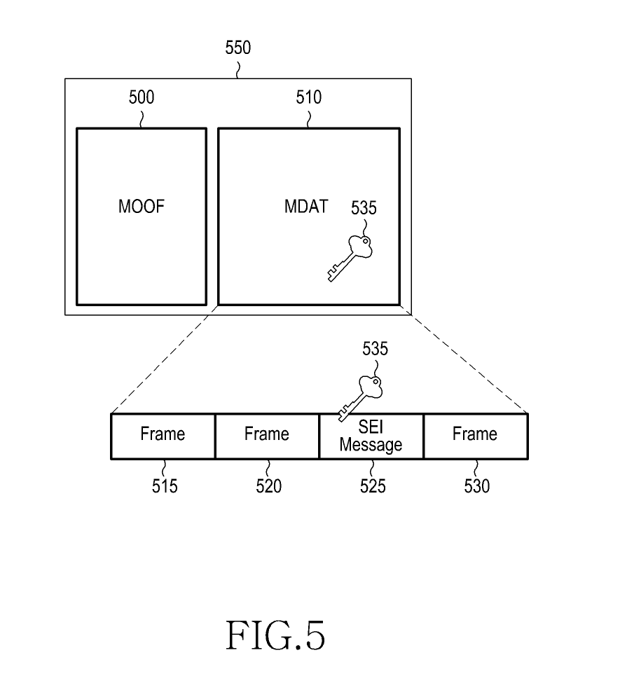

FIG. 5 is a schematic diagram illustrating a structure of the movie fragment 452a through 452e according to an embodiment of the present disclosure.

The movie fragment 452a of FIG. 4 has a structure as shown in FIG. 5. The movie fragment is formed of a movie fragment (MOOF) information 500 and a Media DATa container (MDAT) 510 as shown in the diagram 550. The MOOF 500 includes information indicating information included in the MDAT 510, and the MDAT 510 includes frames 515 and 520, an SEI message 525, and a frame 530. Here, the frames 515, 520, and 530 include audio/video information, and the SEI message 525 includes an encryption key 535. The SEI message 525 is a type of metadata that is provided from a transmitter to help a client device use data.

For this reason, in an embodiment of the present disclosure, the MDAT 510 is a type of container that contains video/audio data, and an SEI message where an encryption key 535 is inserted is inserted into frames 520 and 530 corresponding to video and audio data.

Referring to FIG. 5, the SEI message 525 includes the encryption key 535 that encrypts the movie fragment 452b located after the movie fragment 452a. An example of the SEI message 535 according to an embodiment of the present disclosure is as shown in Table 1.

TABLE 1

Class EncryptionInformationSEIBox extends Box(‘seie’, size)
{
unsigned int(size) encryptioninfosei;
}

Table 1 is provided in a general declarative form of an SEI message according to an embodiment of the present disclosure. EncryptionInformationSEIBox denotes a name of a structure, and ‘seie’ denotes a name of an encryption information box identifier. ‘seie’ is an identifier for a type of an SEI message, and corresponds to an identifier of the SEI message proposed in the present disclosure. For example, when the client device determines an identifier of 4 digits corresponding to seie, the client device may recognize that information included in the box named ‘seie’ is an encryption key. Also, an encryption key is located in encryptioninforsei.

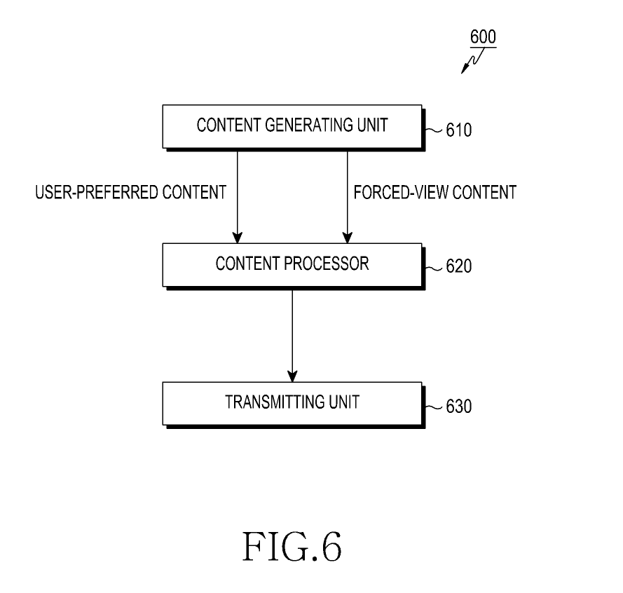

FIG. 6 is a block diagram illustrating a content providing server device 600 according to an embodiment of the present disclosure.

A content generating unit 610 generates a user-preferred content and a forced-view content to be transmitted to a client device according to an embodiment of the present disclosure, and transmits the generated contents to a content processor 620.

The content processor 620 divides the user-preferred content and the forced-view content into data units which are basic units for playback, and performs encryption with respect to at least one data unit from among the data units remaining after excluding a first data unit. The content processor 620 inserts an encryption key (=decryption key) that is capable of decrypting the encrypted data unit, into a data unit located chronologically before the encrypted data unit. In this example, the content processor 620 may encrypt all the data units remaining after excluding the first data unit from the data units, or may encrypt a few data units from among the data units remaining after excluding the first data unit, based on a predetermined criterion. The predetermined criterion is determined by a content provider or a provider.

Also, the content processor 620 inserts, into a last data unit of the data units forming the forced-view content, an encryption key for decrypting the first data unit of the user-preferred content that is located subsequent to the forced-view content. As another example, the content processor 620 may perform encryption with respect to a predetermined data unit of user-preferred content that is located subsequent to the forced-view content, using the encryption key included in the last data unit of the data units forming the forced-view content.

As described above, the content processor 620 encrypts a data unit of the user-preferred content using the encryption key included in a data unit of the forced-view content and thus, a user may inevitably decode the forced-view content so as to obtain the encryption key.

The transmitting unit 630 transmits the data units of the contents generated by the content processor 620, through a network based on an adaptive streaming scheme.

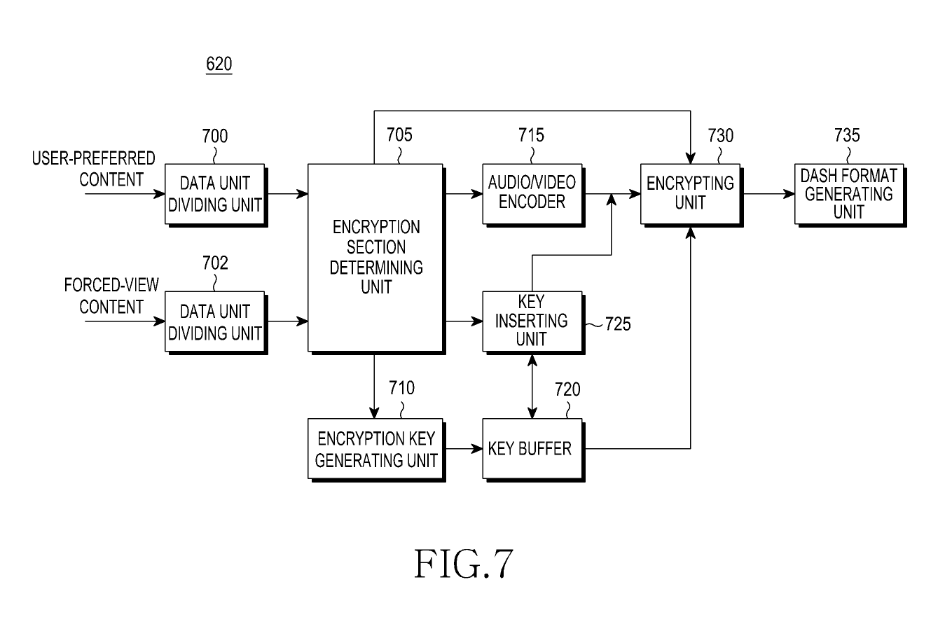

FIG. 7 is a block diagram illustrating the content processor 620 of FIG. 6 according to an embodiment of the present disclosure.

A data unit dividing unit 700 and 702 divides an input user-preferred content and an input forced-view content into data units, and outputs the data units to an encryption section determining unit 705.

The encryption section determining unit 705 determines a data unit to be encrypted from among the data units remaining after excluding a first data unit from the data units of the forced-view content. In this example, the encryption section determining unit 705 may perform encryption with respect to all of the remaining data units or may perform encryption with respect to a few data units.

When the first data unit of the forced-view content is input, the encryption section determining unit 705 instructs an encryption key generating unit 710 to generate an encryption key, and outputs the first data unit to the audio/video encoder 715. The audio/video encoder 715 encodes and outputs the input data unit. The encryption key generating unit 710 generates an encryption key as per the instruction of the encryption section determining unit 705, and performs buffering with respect to the generated encryption key in a key buffer 720. In this example, the encryption key is inserted into the SEI message 525 located between frames corresponding to video and audio data in the MDAT 510. However, the present disclosure may not be limited thereto.

A key inserting unit 725 inserts, into an audio/video encoded data unit, the encryption key buffered in the key buffer 720 as per the instruction of the encryption section determining unit 705.

When the data unit input as per the instruction of the encryption section determining unit 705 corresponds to the first data unit of the forced-view content, an encrypting unit 730 does not perform encryption, and outputs the data unit to a DASH format generating unit 735. The DASH format generating unit 735 generates and outputs data of a DASH format corresponding to a data unit output from the encrypting unit 730 to which an MPD file including information used for receiving the data unit is added.

However, when data units after the first data unit of the forced-view content are input, whether to encrypt the input data units based on a predetermined scheme is reported to the encrypting unit 730. For example, as illustrated in FIG. 4, when it is determined that encryption is to be performed with respect to all of the data units remaining after excluding the first data unit of the forced-view content, and a second data unit is input to the encryption section determining unit 705, the encrypting unit 730 is informed that the second data unit is encrypted using an encryption key generated in the encryption key generating unit 710 when the first data unit is input. The encryption section determining unit 705 instructs the encryption key generating unit 710 to generate an encryption key to be included in the second data unit, and simultaneously, instructs the key inserting unit 725 to insert the encryption key into the second data unit. When a third data unit is input, the encryption section determining unit 705 instructs the encrypting unit 730 to perform encryption using the encryption key included in the second data unit, and instructs the encryption key generating unit 710 to generate an encryption key for encrypting a fourth data unit, and instructs the key inserting unit 725 to insert the encryption key for the fourth data unit into the third data unit.

The process may be performed repeatedly during a predetermined encryption section.

The encryption section determining unit 705 determines a data unit to be encrypted from among the data units of the user-preferred content, and instructs the encrypting unit 730 to encrypt the data unit determined to be encrypted using an encryption key inserted into the encrypted forced-view content.

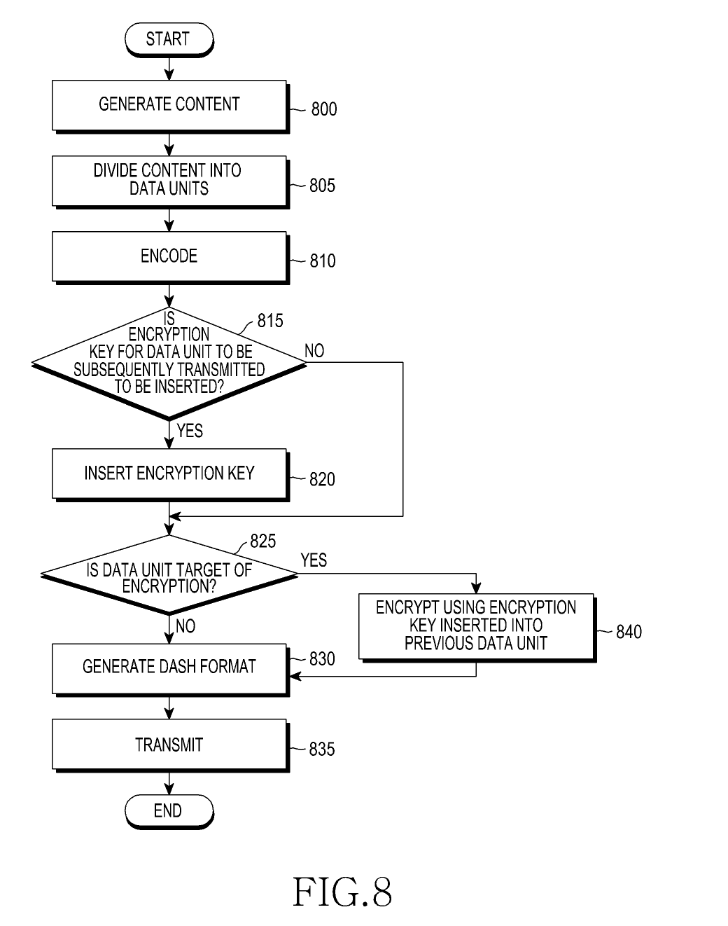

FIG. 8 is a schematic flowchart of a method of a server device that generates and transmits a content according to an embodiment of the present disclosure.

The server device generates a content at operation 800, and divides the generated content into data units at operation 805. The server device performs audio/video encoding with respect to the data units based on a predetermined scheme at operation 810, and determines whether to insert an encryption key for a data unit to be transmitted after the data unit encoded at operation 810, at operation 815. A data unit to which the encryption key is to be inserted by the server device at operation 815 is determined based on a scheme predetermined by a provider and the like.

When it is determined that the server device needs to insert an encryption key for a data unit to be subsequently transmitted, the encryption key is generated at operation 820, the encryption key is inserted into the encoded data unit as illustrated in FIG. 5, and whether the data unit is a target of encryption is determined at operation 825.

Conversely, when the server device determines to not insert the encryption key for the data unit to be subsequently transmitted, the server device proceeds with operation 825.

At operation 825, the server device determines whether the data unit is a target of encryption. When a result of determination at operation 825 shows that the data unit is the target of encryption, the data unit is encrypted using an encryption key inserted into a previous data unit in operation 840, and then proceeds with operation 830.

Conversely, when the result of the determination at operation 825 shows that the data unit is different from the target of encryption, the server device generates a content in a DASH format for transmission based on a DASH scheme at operation 830, and transmits the content at operation 835.

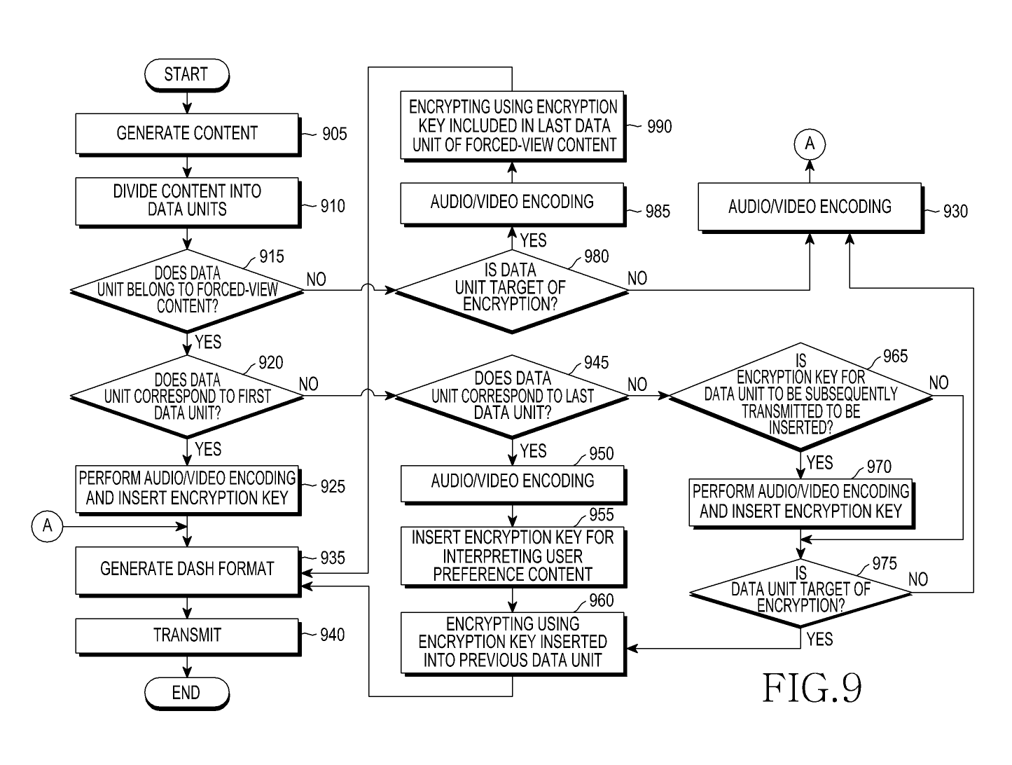

FIG. 9 is an operational flowchart of a server device that generates and transmits a forced-view content and a user-preferred content according to an embodiment of the present disclosure.

The server device generates a content at operation 905, and divides the content into data units at operation 910. At operation 915, the server device determines whether a data unit obtained from the division at operation 910 belongs to the forced-view content or belongs to the user-preferred content. When the data unit belongs to the forced-view content, the server device determines whether the data unit corresponds to a first data unit at operation 920.

When a result of the determination at operation 920 shows that the data unit corresponds to the first data unit, the server device performs audio/video encoding and inserts an encryption key into the data unit at operation 925, generates a DASH format at operation 935, and transmits the DASH format at operation 940.

Conversely, when the result from operation 920 shows that the data unit does not correspond to the first data unit, the server device determines whether the data unit corresponds to a last data unit at operation 945. When a result from operation 945 shows that the data unit corresponds to the last data unit, the server device performs audio/video encoding at operation 950, and inserts an encryption key for decrypting the user-preferred content into the data unit at operation 955. The server device encrypts the data unit that is audio/video encoded at operation 950 using an encryption key inserted into a previous data unit at operation 960, and proceeds with operation 935.

When a result of the determination at operation 915 shows that the data unit does not belong to the forced-view content, the server device determines that the data unit belongs to the user-preferred content and determines whether the data unit is a target of encryption at operation 980.

When a result of the determination at operation 980 shows that the data unit is the target of encryption, the server device performs audio/video encoding at operation 985, encrypts the encoded audio/video data using an encryption key included in the last data unit of the forced-view content at operation 990, and proceeds with operation 935. The data unit encrypted using the encryption key included in the last data unit of the forced-view content at operation 990 is a data unit of a predetermined location from among the data units forming the user-preferred content.

Conversely, when the result of determination at operation 980 shows that the data unit is not the target of encryption, the server device performs audio/video encoding at operation 930, and proceeds with operation 935.

When the result from operation 945 shows that the data unit does not correspond to the last data unit from among the data units of the forced-view content, the server device determines whether to insert an encryption key for a data unit to be subsequently transmitted at operation 965. When a result from operation 965 shows that the encryption key for the data unit to be subsequently transmitted does not need to be inserted, the server device proceeds to operation 975, which is described below.

When a result from operation 965 shows that the encryption key for the data unit to be subsequently transmitted needs to be inserted, the server device performs audio/video encoding and inserts the encryption key at operation 970. At operation 975, the server device determines whether the data unit into which the encryption key is inserted at operation 970 is a target of encryption, and when the data unit is the target of encryption, the server device performs encryption using an encryption key inserted into a previous data unit at operation 960. When the data unit is not the target of encryption, the server device proceeds with operation 930.

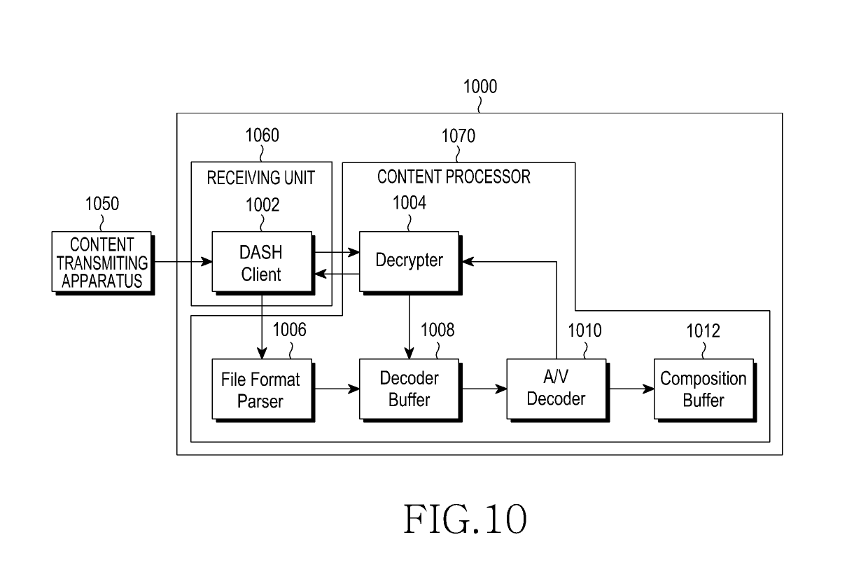

FIG. 10 is a block diagram illustrating of a user client device 1000 that receives and provides a content to a user according to an embodiment of the present disclosure.

A content transmitting apparatus 1050 stores a DASH content, and may be a service providing server of a service provider that provides a network DASH content.

The client device 1000 downloads a DASH content from the content transmitting apparatus 1050, and plays back or stores the DASH content, and the client device 1000 corresponds to all devices that are capable of storing and playing back the DASH content so as to provide the DASH content to a user. Also, the client device 1000 connects to the content transmitting apparatus 1050 so as to be aware of which DASH content is included, and receives an MPD and Initialization Segment (IS)/Media Segment (MS) used for playing back the content.

The client device 1000 includes a DASH client 1002, a decrypting unit 1004, a file format parser 1006, a decoder buffer 1008, an audio/video decoder 1010, and a composition buffer 1012.

The DASH client 1002 reads a received DASH content and decrypts an MPD, and downloads an IS and MS based on a network and an adaptation parameter provided from the DASH. The file format parser 1006 is a module that may interpret multimedia content configuration information in the IS and the MS written in a form of a file format. In particular, the file format parser 1006 interprets the MS so as to extract a data unit corresponding to a movie fragment or a media segment. The file format parser 1006 outputs the data unit extracted from the received DASH content to the decoder buffer 1008.

The decrypting unit 1004 decrypts the data unit corresponding to the media segment or the movie fragment, which is encoded and buffered in the decoder buffer 1008, using an encryption key obtained during an audio/video decoding process on a previously received data unit.

The decoder buffer 1008 temporarily stores data to be input to the audio/video decoder 1010. In this example, when the encoded data unit is stored in the decoder buffer 1008, the stored data is decrypted by the decrypting unit 1004.

The audio/video decoder 1010 decodes the audio and video data so as to generate an intact frame or a partial screen/voice.

The composition buffer 1012 receives the frame or the partial screen/voice generated by the audio/video decoder 1010 and temporarily stores the same. That is, when a media segment or a movie fragment stored in the decoder buffer 1008 is encrypted, the decrypting unit 1004 decrypts the media segment or the movie fragment stored in the decoder buffer 1008 using an encryption key. In this example, the encryption key used for decryption is obtained when audio/video decoding is performed with respect to the previously received data unit. In this example, when it is determined that the data unit buffered in the decoder buffer 1008 is encrypted, the audio/video decoder 1010 informs the decrypting unit 1004 that the data unit buffered in the decoder buffer 1008 is encrypted. The decrypting unit 1004 decrypts the data unit buffered in the decoder buffer 1008 using the previously received and stored encryption key, and the audio/video decoder 1010 performs audio/video decoding with respect to the data unit decrypted by the decrypting unit 1004, and outputs the same to the composition buffer 1012.

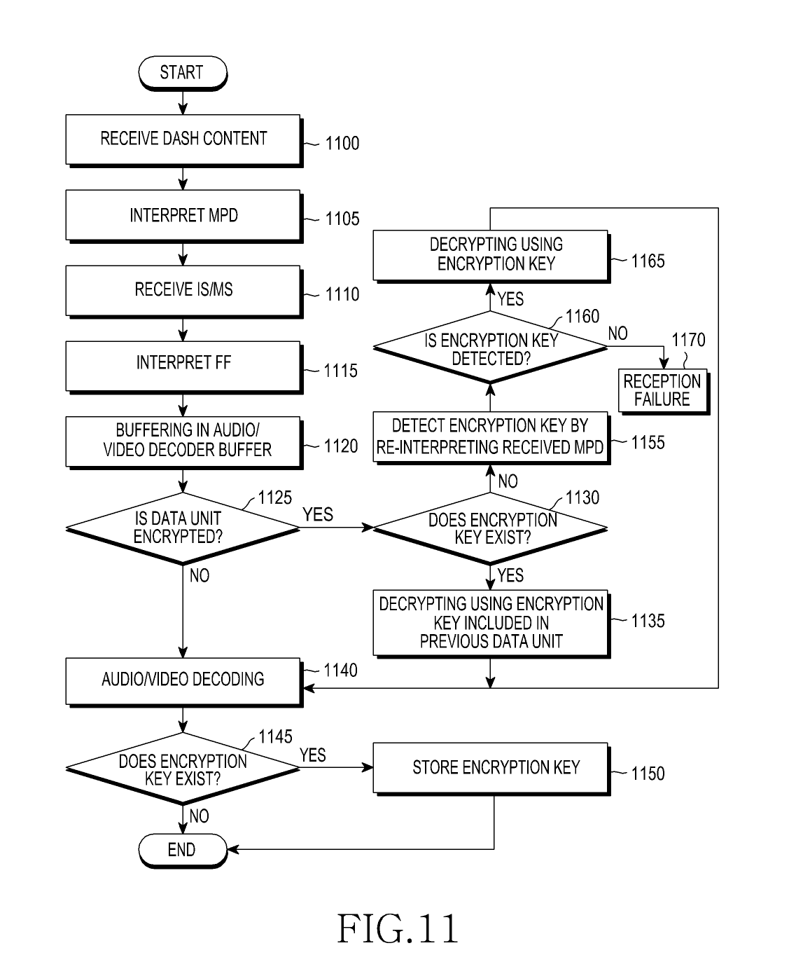

FIG. 11 is a flowchart of a content receiving method of the client device 1000 according to an embodiment of the present disclosure.

The client device 1000 receives a DASH content at operation 1100, and interprets an MPD at operation 1105. The client device 1000 receives an IS/MS at operation 1110, and interprets an FF at operation 1115. At operation 1120, the client device 1000 buffers a data unit of a content of which FF is interpreted in an audio/video decoder buffer, and determines whether the data unit is encrypted at operation 1125.

When a result of the determination at operation 1125 shows that the data unit is encrypted, the client device 1000 determines whether an encryption key exists at operation 1130. When the encryption key exists at operation 1130, the client device 1000 performs decryption using the encryption key included in a previous data unit at operation 1135. The client device 1000 performs audio/video decoding at operation 1140, and determines whether an encryption key exists in the data unit that is audio/video decoded at operation 1140, at operation 1145. When a result of the determination at operation 1145 shows that the encryption key exists, the client device 1000 stores the encryption key at operation 1150, and when the encryption key does not exist, an operation is terminated. Conversely, when the result of determination at operation 1125 shows that the data unit is not encrypted, there is no need of decryption and thus, the client device 1000 directly proceeds with operation 1140.

When the result of the determination at operation 1130 shows that the encryption key for decrypting the encrypted data does not exist, the client device 1000 re-interprets the MPD received at operation 1155 so as to detect the encryption key. When the encryption key is detected by re-interpreting the MPD in operation 1160, the client device 1000 decrypts the encrypted data unit using the detected encryption key at operation 1165, and proceeds with operation 1140. However, if the encryption key is not detected at operation 1160, the client device 1000 has no way to decrypt the encrypted data unit and thus, may report reception failure at operation 1170.

As described above, according to an embodiment of the present disclosure, an encryption key is configured to be recognized as a subsidiary information when the audio/video decoder 1010, as opposed to the file format parser 1006, decodes an audio/video content. Therefore, the encryption key may not be obtained by merely parsing a media segment from a DASH content downloaded by the client device 1000, and a process comparable to a playback process is used to obtain the encryption key.

Here, the process comparable to the playback process indicates the operations remaining after excluding a fourth operation that outputs a decoded result on a screen, from among the four operations generally performed for playing back a content, that is, a first operation that inputs video and audio data, a second operation that decodes input data and buffers data in a buffer every time that video/audio data exists, a third operation that forms a frame with buffered data, and the fourth operation that outputs the decoded result to the screen.

In the client device 1000, the DASH client 1002 is referred to as a receiving unit 1060, and the decrypting unit 1004, the file format parser 1006, and the decoder buffer 1008, the audio/video decoder 1010, and the composition buffer 1012 are referred to as a content processor 1070. Therefore, in an embodiment of the present disclosure, the receiving unit 1060 receives a DASH content including a user-preferred content and a forced-view content as data units which are basic units for playback. The content processor 1070 determines whether encryption is performed with respect to the received data unit, and when the data unit is encrypted, the received data unit is decrypted using an encryption key included in a previously received data unit. The decrypted data unit is audio/video decoded and output to a user.

As described in FIG. 4, according to a configuration of a content, each of the plurality of successive movie fragments included in an advertising content has an encryption key for a directly subsequent movie fragment and thus, the content may not be played back without playing back a first movie fragment of a first media segment included in the advertising content located first.

A portion encrypted according to an embodiment of the present disclosure may be a portion of a media segment, and an entirety of the media segment. That is, the encrypted area may be a few video/audio frames in the media segment, all video/audio frames in the media segment, or the entirety of the media segment, and the like. In general, a single movie fragment includes a plurality of pieces of frame information, and a single media segment includes a plurality of movie fragments. Therefore, the single media segment includes a plurality of movie fragments (a plurality of pieces of frame information) and thus, encrypting a portion or an entirety of frame information in the media segment indicates designating a few or all frames as a target of encryption. Encrypting the entire media segment indicates encrypting styp information indicating a declarative part of a media segment and sidx indicating index information associated with a movie fragment in addition to encryption of a movie fragment.

Accordingly, the client device 1000 according to an embodiment of the present disclosure may not play back an encryption section from the middle of the encrypted section without playing back the entire encrypted section included in a data unit of a forced-view content such as an advertisement. Therefore, an embodiment of the present disclosure encrypts a first data unit, an arbitrary data unit, or a plurality of successive data units included in a user-preferred content is configured to be included in an encrypted section that is encrypted using an encryption key included in a data unit of a forced-view content so that playback of the forced-view content is a precondition of playback of the user-preferred content.

Therefore, when a malicious user hacks the client device 1000 to not play back the forced-view content, the user may fail to view the user-preferred content in an embodiment of the present disclosure. When the client device plays back the forced-view content, the client device is aware of an encryption key and thus, may be aware of the encryption key for an encrypted data unit of the user-preferred content. Although the client device randomly accesses the user-preferred content again based on an encrypted data unit while the user-preferred content is already played back, the user-preferred content may be played back.

In this manner, when the client device 1000 according to an embodiment of the present disclosure randomly accesses the user-preferred content through manipulation by a user before the forced-view content begins, and skips the forced-view content, an encryption key used for playing back the user-preferred content may not be obtained and thus, an encrypted data unit of the user-preferred content may not be decoded and the user-preferred content may not be played back.

According to another embodiment of the present disclosure, an encryption key may be inserted into an SEI message, as opposed to a metadata. However, the metadata may be interpreted by the file format parser 1006 of the client device 100 and thus, may have a lower security level than decoding by the audio/video decoder 1010.

The above-described various embodiments of the present disclosure may be embodied as a non-transitory recoding medium that is capable of performing recoding in a computer. The recording medium that is capable of performing recoding in a computer is a data storage device that is capable of storing data that a computer system may read. Examples of the non-transitory recoding medium that that is capable of performing recoding in a computer includes a Read Only Memory (ROM), a Random Access Memory (RAM), a Compact Disk (CD), a magnetic tape, a floppy disk, and an optical data storage device, but the recording medium is not limited thereto.

While the present disclosure has been shown and described with reference to various embodiments thereof, it will be understood by those skilled in the art that various changes in form and details may be made therein without departing from the spirit and scope of the present disclosure as defined by the appended claims and their equivalents.

1. A method of transmitting a content in a broadcasting system, the method comprising:
generating a user-preferred content and a forced-view content;
dividing the user-preferred content and the forced-view content into data units; and
repeatedly performing encryption by inserting an encryption key into at least one data unit from among the data units remaining after excluding a first data unit from the data units forming the forced-view content,
wherein the encryption key corresponds to a key that is capable of decrypting a next data unit for each data unit.

2. The method of claim 1, wherein the encryption key is inserted into a data unit that is placed chronologically before the encrypted data unit.

3. The method of claim 1, wherein the data unit includes at least one of a media segment and a movie fragment.

4. The method of claim 1, wherein a last data unit of the data units forming the forced-view content includes an encryption key for decrypting one of an entirety and a few of the data units of the user-preferred content that is placed subsequent to the forced-view content.

5. The method of claim 1, wherein a last data unit of the data units forming the forced-view content includes an encryption key for decrypting a data unit placed in a predetermined location of the user-preferred content that is placed directly after the forced-view content.

6. The method of claim 1, wherein the forced-view content is one of an advertisement, a notification message, and an emergency message reporting an emergency situation.

7. The method of claim 1, wherein the encryption key is included in a Supplementary Enhanced Information (SEI) message of each data unit.

8. An apparatus for transmitting a content in a broadcasting system, the apparatus comprising:
a content generating unit that generates a user-preferred content and a forced-view content; and
a content processor that divides the user-preferred content and the forced-view content into data units that are basic units for playback, and repeatedly performs encryption by inserting an encryption key into at least one data unit from among the data units remaining after excluding a first data unit from the data units forming the forced-view content,
wherein the encryption key includes a key for decrypting a next data unit for each data unit.

9. The apparatus of claim 8, wherein the encryption key for decrypting the encrypted data unit is inserted into a data unit placed chronologically before the encrypted data unit.

10. The apparatus of claim 8, wherein the data unit includes at least one of a media segment and a movie fragment.

11. The apparatus of claim 8, wherein a last data unit of the data units forming the forced-view content includes an encryption key for decrypting one of an entirety and a few of the data units of the user-preferred content that is placed subsequent to the forced-view content.

12. The apparatus of claim 8, wherein a last data unit of the data units forming the forced-view content includes an encryption key for decrypting a data unit placed in a predetermined location of the user-preferred content placed directly after the forced-view content.

13. The apparatus of claim 8, wherein the forced-view content is one of an advertisement, a notification message, and an emergency message reporting an emergency situation.

14. The apparatus of claim 8, wherein the encryption key is included in a Supplementary Enhanced Information (SEI) message of each data unit.

15. A method of receiving a content in a broadcasting system, the method comprising:
receiving, from a server, data units including a user-preferred content and a forced-view content;
determining whether encryption is performed with respect to the received data units;
decrypting a data unit of the received data units using an encryption key included in a previously received data unit when encryption is performed; and
performing audio/video decoding with respect to the decrypted data unit.

16. The method of claim 15, wherein, when encryption is not performed, the method further comprises:
determining whether an encryption key is included in a data unit of the received data units,
wherein the encryption key included in the data unit of the received data units is used for decrypting an encrypted data unit which is to be received after the data unit of the received data units.

17. The method of claim 15, wherein the data unit includes at least one of a media segment and a movie fragment.

18. The method of claim 15, wherein a last data unit of the data units forming the forced-view content includes an encryption key for decrypting one of an entirety and a few of the data units of the user-preferred content that is placed subsequent to the forced-view content.

19. The method of claim 15, wherein a last data unit of the data units forming the forced-view content includes an encryption key for decrypting a data unit placed in a predetermined location of the user-preferred content that is placed directly after the forced-view content.

20. The method of claim 15, wherein the forced-view content is one of an advertisement, a notification message, and an emergency message reporting an emergency situation.

21. The method of claim 15, wherein the encryption key is included in a Supplementary Enhanced Information (SEI) message of the data unit.

22. An apparatus for receiving a content in a broadcasting system, the apparatus comprising:
a receiving unit that receives, from a server, data units including a user-preferred content and a forced-view content;
a content processor that determines whether encryption is performed with respect to the received data units, decrypts a data unit of the received data units using an encryption key included in a previously received data unit when encryption is performed, and performs audio/video decoding with respect to the decrypted data unit.

23. The apparatus of claim 22, wherein the content processor performs:
determining whether an encryption key is included in a data unit of the received data units when the encryption is not performed,
wherein the encryption key included in the data unit of the received data units is used for decrypting an encrypted data unit which is to be received after the data unit of the received data units.

24. The apparatus of claim 22, wherein the data unit includes at least one of a media segment and a movie fragment.

25. The apparatus of claim 22, wherein a last data unit of the data units forming the forced-view content includes an encryption key for decrypting one of an entirety and a few of data units of the user-preferred content that is placed subsequent to the forced-view content.

26. The apparatus of claim 22, wherein a last data unit of the data units forming the forced-view content includes an encryption key for decrypting a data unit placed in a predetermined location of the user-preferred content that is placed directly after the forced-view content.

27. The apparatus of claim 22, wherein the forced-view content is one of an advertisement, a notification message, and an emergency message reporting an emergency situation.

28. The apparatus of claim 22, wherein the encryption key is included in a Supplementary Enhanced Information (SEI) message of the data unit.
